(19) United States
(12) Patent Application Publication
(10) Pub. No.: US 2009/0272033 A1
(43) Pub. Date: Nov. 5, 2009

(54) BIODEGRADABLE SEED GERMINATING PODS FOR SEEDLINGS

(76) Inventor: Ronald Irineu PALEARI, Jardim Nikko (BR)

Correspondence Address: DEFILLO & ASSOCIATES, INC., P.O. Box 14104, Clearwater, FL, 33766, US

(21) Appl. No.: 12/434,720

(22) Filed: May 4, 2009

(30) Foreign Application Priority Data
May 5, 2008 (AU) 2008201986

(51) Int. Cl. A01G 9/10; A01G 9/02; A01G 23/02

(52) U.S. Cl. 47/74; 47/86; 47/77

(57) ABSTRACT

The present invention relates to a “BIODEGRADABLE GERMINATING PODS FOR SEEDLINGS”, having a main body formed by a tray or individual tubular pods having conical or other geometrical shape, and a sleeve with a passing hole in its lower end; the tubular pods have longitudinal guiding crevices or tracks; their upper end has a circular rim and its underside functions as a base for resting the tubular pod on the tray. The top section of the tray has several cavities placed equidistantly from each other, forming several tubular pods in its lower section, which are provided with passing holes. The body of the tubular pods itself consists of 20 to 70% cellulose, 5 to 20% calcium carbonate, 30 to 70% calcium sulfate, and the following micronutrients which are added according to the deficiency of such nutrients in the area where the seedlings will be planted: 0.001 to 15% Copper (Cu), 0.001 to 15% Zinc (Zn), 0.001 to 15% Magnesium (MG), 0.001 to 15% Iron (Fe), 0.001 to 15% Sulfur (S), 0.001 to 10% Boro (B), 0.001 to 10% Sodium (Na), 0.001 to 10% Manganese (Mn), 0.001 to 5% Molybdenum (Mo), 0.001 to 5% Cobalt (Co); micronutrients are added in the proportion of up to 5% for vegetable seedlings, up to 10% for fruit tree seedlings, and up to 15% for reforestation seedlings.

### FIELD OF THE INVENTION

This patent request pertains to the invention of a device denominated “BIODEGRADABLE SEED GERMINATING PODS FOR SEEDLINGS,” which was developed with the purpose of promoting the biodegradation of the germinating pod only after its definitive planting, providing the seedling the necessary time for rooting according to the plant species, until the seedling is ready to be transferred and planted in its definite site.

The invention also has the purpose of avoiding the removal of the plant from its germinating medium which causes micro and macro lesions on the radicular system of the seedling, thus exposing the plant to infections by fungi, bacteria and other microorganisms which are aggressive to the seedling. This fact eliminates the stress which involves such removal, which delays the development of the seedling in its definite site.

Other objectives of the invention are to provide the seedling some minerals and micronutrients which are essential for its development, as well as soil correction in the area where the root system of the plant will grow when the seedling is to be planted in its definite site.

Other objectives of the invention are the protection of the seedling against droughts, since the cellulose structure of the biodegradable germinating pot retains humidity for a longer period of time, and the thermal protection provided by the invention, especially in warm and sandy areas, avoiding the propagation of heat into the initial radicular system of the plant.

### BACKGROUND OF THE INVENTION

It is well known that the germination and development of seeds are more effective when they take place in individual containers, which is usually done by utilizing individual plastic tubes or expanded polyethylene trays, or plastic material with individual pyramid shaped cavities, and even small coffee cups (50 ml), all presenting the same effectiveness as far as the germination of the seeds in concerned. At the time of transplanting the seedlings, however, with the removal of the seedlings from their germinating media, there is a loss of seedlings resulting from the breaking of sensitive seedlings as well as damages to the radicular system of the plant, without mentioning the loss of expanded polyethylene and PVC media by breakages due to handling, and also the action of rodents prior to the planting of the seeds.

There are other problems that specifically pertain to PVC, plastic or expanded polyethylene pots, which is the environmental pollution caused by the disposal of damaged pots; additionally, and even more serious, is the necessity to transport the germinating pots back to the nursery and to decontaminate them, thus exposing the nursery to the constant risk of contamination by microorganisms coming from the fields, considering that the nursery ought to be an environment which is free from contaminants and diseases that affect the seedlings.

### SUMMARY OF THE INVENTION

This invention pertains to “BIODEGRADABLE GERMINATING PODS FOR SEEDLINGS”, which consist of a principal body formed by a tray or individual tubular pods having conical or other geometrical shape, and a cavity with a passing hole in its lower section; the tubular pods have longitudinal guiding crevices or tracks; their top section has a circular rim and its underside provides a base for resting the tubular pod on the tray. The top section of the tray has several cavities placed equidistantly from each other, forming several tubular pods in its lower section, which are provided with passing holes.

The body of the tubular pods itself consists of 20 to 70% cellulose, 5 to 20% calcium carbonate, 30 to 70% calcium sulfate, and the following micronutrients which are added according to the deficiency of such nutrients in the area where the seedlings will be planted: 0.001 to 15% Copper (Cu), 0.001 to 15% Zinc (Zn), 0.001 to 15% Magnesium (MG), 0.001 to 15% Iron (Fe), 0.001 to 15% Sulfur (S), 0.001 to 10% Boro (B), 0.001 to 10% Sodium (Na), 0.001 to 10% Manganese (Mn), 0.001 to 5% Molybdenum (Mo), 0.001 to 5% Cobalt (Co); micronutrients are added in the proportion of up to 5% for vegetable seedlings, up to 10% for fruit tree seedlings, and up to 15% for reforestation seedlings.

### BRIEF DESCRIPTION OF THE DRAWINGS

In order to provide a complete explanation of the device, illustrations are appended which contain numerical references along with detailed description, as follows:

FIG. 1 shows a perspective view of the pods according to the present invention.

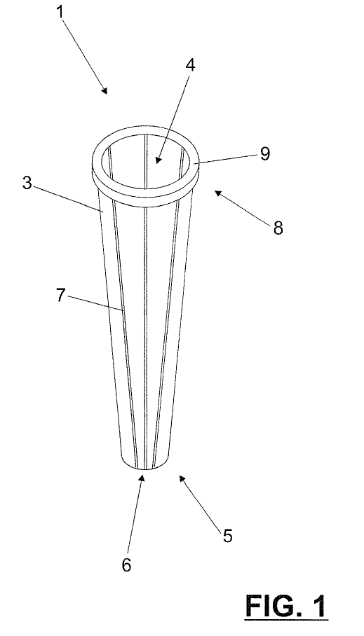

FIG. 2 shows a cutaway view of the pod according to FIG. 1.

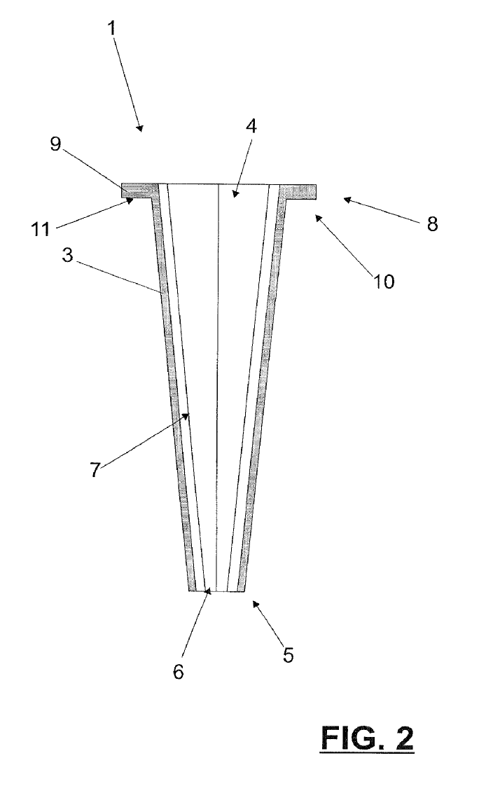

FIG. 3 shows a top view of the tray according to the present invention.

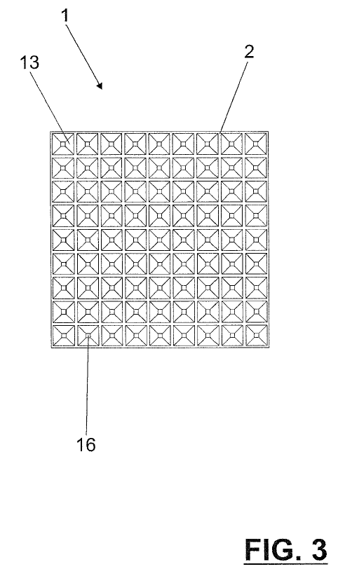

FIG. 4 shows a side view of the tray according to the present invention.

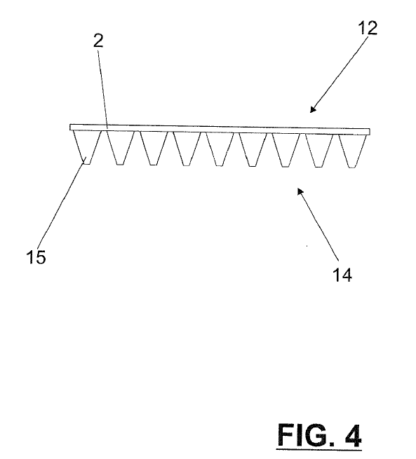

### DESCRIPTION OF THE INVENTION

As inferred by the drawings, the “BIODEGRADABLE GERMINATING PODS FOR SEEDLINGS”, consisting of a main body (1) formed by a tray (2) or individual tubular pods (3) having conical or other geometrical shape, and a cavity (4) with a passing hole (6) in its lower end (5); the tubular pods have longitudinal guiding crevices or tracks (7); their upper end (8) has a circular rim (9) and the underside of such rim (10) functions as a base (11) for resting the tubular pod on the tray (2). The top section (12) of the tray has several cavities (13) placed equidistantly from each other, forming several tubular pods (15) in its lower section (14), which are provided with passing holes (16). The body (1) of the tubular pods itself consists of 20 to 70% cellulose, 5 to 20% calcium carbonate, 30 to 70% calcium sulfate, and the following micronutrients which are added according to the deficiency of such nutrients in the area where the seedlings will be planted: 0.001 to 15% Copper (Cu), 0.001 to 15% Zinc (Zn), 0.001 to 15% Magnesium (MG), 0.001 to 15% Iron (Fe), 0.001 to 15% Sulfur (S), 0.001 to 10% Boro (B), 0.001 to 10% Sodium (Na), 0.001 to 10% Manganese (Mn), 0.001 to 5% Molybdenum (Mo), 0.001 to 5% Cobalt (Co); micronutrients are added in the proportion of up to 5% for vegetable seedlings, up to 10% for fruit tree seedlings, and up to 15% for reforestation seedlings.

According to the description, the “BIODEGRADABLE GERMINATING PODS FOR SEEDLINGS” present many advantages, since the biodegradable germinating pods do not need to be transported back to the nursery, and they also fertilize and correct the soil. In addition, they allow for early growth and a high level of development of the seedling due to several factors. Among such factors are the better aeration of the germination mix contained in the pods, thermal isolation, and longer retention of humidity. The transplanting of the seedling thus obtained can be done in half the time required for seedlings grown in plastic pots. In addition, after transplanting the seedlings presented substantial growth advantages due to the fact that since the pods are biodegradable, the plants were not exposed to the stress resulting from the removal of the seedlings from their pots, which causes lesions and breaking of the radicular system of the seedlings.

Tests revealed that the amount of calcium released for the seedling prior to definitive planting was 10% of the total amount available; the remaining amount becomes available in the definitive site as the calcium present in the pods become soluble. Minerals such as Nitrogen (N), Phosphor (P), Potassium (K) may be added to the biodegradable germinating pods, and will be released to the seedling and later in the soil. In addition, as the biodegradable pods become soluble after definitive planting, they release part of the micronutrients which are part of their structure.

Several different shapes and sizes of germinating trays and pods can be produced according to the requirement and purpose of the seedling, as well as the time the seedling will remain in the nursery. The pods can be molded individually or as a tray, containing 100, 200, 300 or more individual pyramid shaped sleeves, or sleeves with a pyramid shaped body and square, triangular or circular base.

Since the device is innovative and previously not available in the state of the technique, it falls into the criteria which define a patent for an invention. The following are the claims.

1-3. (canceled)

4. A biodegradable germinating pods for seedlings comprising:
a main body formed by a tray containing at least one tubular pod;
wherein each tubular pod includes an upper end, a lower end, a side wall, and a cavity including a passing hole in the lower end;
wherein each tubular pod has longitudinal guiding crevices or tracks;
wherein the upper end of each tubular pod has a circular rim having a underside portion;
wherein the underside of the rim functions as a base for resting the tubular pod on the tray;
wherein the tray has a top section including several cavities placed equidistantly from each other;
wherein the tubular pod is placed on the cavity.

5. The biodegradable germinating pods for seedlings according to claim 4, wherein the tubular pod is comprised of 20 to 70% cellulose, 5 to 20% calcium carbonate, 30 to 70% calcium sulfate, and the following micronutrients which are added according to the deficiency of such nutrients in the area where the seedlings will be planted: 0.001 to 15% Copper (Cu), 0.001 to 15% Zinc (Zn), 0.001 to 15% Magnesium (MG), 0.001 to 15% Iron (Fe), 0.001 to 15% Sulfur (S), 0.001 to 10% Boro (B), 0.001 to 10% Sodium (Na), 0.001 to 10% Manganese (Mn), 0.001 to 5% Molybdenum (Mo), 0.001 to 5% Cobalt (Co); micronutrients are added in the proportion of up to 5% for vegetable seedlings, up to 10% for fruit tree seedlings, and up to 15% for reforestation seedlings.

6. The biodegradable germinating pods for seedlings according to claim 4, wherein the body contains Nitrogen (N), Phosphor (P), and Potassium (K) which are available to the seedlings and the soil.

7. The biodegradable germinating pods for seedlings according to claim 4, wherein the tubular pods has a conical shape.
